(19) United States
(12) Patent Application Publication
(10) Pub. No.: US 2019/0363325 A1
(43) Pub. Date: Nov. 28, 2019

(54) BATTERY SEPARATOR MEMBRANE DRYING DEVICE AND METHOD

(71) Applicant: WEI HAO LIAO, Taipei (TW)

(72) Inventor: WEI HAO LIAO, Taipei (TW)

(21) Appl. No.: 15/985,716

(22) Filed: May 22, 2018

(51) Int. Cl. H01M 2/14; H01M 10/04; H01M 2/18

(52) U.S. Cl. CPC H01M 2/145; H01M 10/0431; H01M 10/0409; H01M 10/0459; H01M 10/045; H01M 2/18

(57) ABSTRACT

A device and a method for drying a battery separator membrane. The method is mainly by adding a drying device to provide a drying process prior to the lamination in the battery automated manufacturing process, so that in the process of sequentially, stacking the positive, negative electrode plates and the separator membrane in an interval into a battery cell, the drying device is used to continuously dry the separator membrane in advance to ensure that the moisture content of the separator membrane itself is effectively removed. The drying device mainly includes a closed space, and a plurality of sets of rollers at a certain distance from each other is arranged arbitrarily to make the long strip-shaped separator membrane wind around all the rollers to get a fully unfolded state. This couples with the introduction of continuous circulating wind into the closed space to blow the separator membrane to achieve the desired drying effect.

### BACKGROUND OF INVENTION

### 1. Field of the Invention

The present invention relates generally to a battery manufacturing process, and more particularly to a thin film type battery separator membrane drying device and method applicable to full-automatic blanking to encapsulation integration production.

### 2. Description of Related Art

Lithium secondary batteries use anhydrous organic solvents or organic polymers as the electrolyte and require no water molecules inside the battery. On the one hand, because lithium metal has high chemical activity, lithium metal contacting with water will cause a violent chemical reaction, which may result in battery explosion. On the other hand, the reaction of water molecules with the electrolyte will cause poisoning of the lithium secondary battery and may easily reduce the service life of the lithium secondary battery.

As shown in FIG. 1, the current battery with aluminum-plastic film as the battery encapsulation material in the integrated production process mainly includes: (A) a die blanking process of electrode plates and electrode ears, (B) a lamination process of electrode plates, (C) a welding process of electrode ears, (D) an encapsulation process of battery cell with aluminum-plastic film, (E) a baking process of battery cells, and (F) a electrolyte injection process into the battery cell. With regard to the baking process, the aluminum-plastic film is principally packaged well, but the battery cell structure with one side being left uncovered is sent into the baking machine for thorough baking and drying to make the whole battery cell completely dehydrated. It is followed by the next electrolyte injection process.

From the above statement, it is known that for the moisture source in the battery production process, the current manufacturers are mainly aiming at the separator membrane or the environmental humidity in the manufacturing space as a control item and means. Since the separator membrane itself is a porous plastic film, water absorbability is very large, and moisture generally will not react with the separator membrane. As long as going through the baking, moisture can be substantially eliminated, so there is little strict moisture control for the separator membrane. However, controlling the humidity in the air or removing moisture as much as possible needs higher cost and more price; even in the end a certain amount of water molecules left over in the process cannot be avoided.

At present, the baking methods adopted by most manufacturers are mainly to remove from the production line the battery cell structure that has been encapsulated in an aluminum-plastic film except leaving one side open, and put it into the baking machine one by one to carry out baking and drying, so as to completely eliminate the moisture content in the aluminum-plastic film (especially the separator membrane itself). The average baking time is about 72 hours. After completion, the battery cell structure is returned to the production line for the next electrolyte injection operation.

However, such a practice of removing the battery cell structure from the production line first and then followed by baking and drying not only interrupts the automation of mass production, but also reduces the overall production efficiency. In particular; the separator membrane for isolating the multilayered positive, negative electrode plates has already been pressed therein, and moisture is not easily eliminated. If the baking and drying are performed at this time, the baking time will be lengthened on the one hand; on the one hand a space must be sought for a large number of battery cell structures to be placed for waiting for the completion of baking operation. After completion; the battery cell structure will be transported back to the automation line for electrolyte injection. As a whole, the baking process is not only time-consuming and labor-intensive, but also interrupts the automated operation of mass production. It also requires time and labor for the secondary processing, which does not meet the economic benefits.

Therefore, how to solve the above-mentioned disadvantages in battery manufacture and provide a battery manufacturing method that can further shorten the process time and improve the production efficiency in an all-round way are the key R&D and breakthrough direction for the industry should to work harder.

### SUMMARY OF THE INVENTION

The primary objective of the present invention is to provide a battery separator membrane drying device and method, which can solve the problem that the production line must be interrupted during the baking and drying of the battery cells in the conventional battery manufacturing process. The separator membrane is fully dried before the battery cell lamination process to shorten the processing time and achieve the benefits of full-automatic blanking to encapsulation integration production.

According to the purpose of the present invention, the inventor of the present invention proposes a device and a method for drying a battery separator membrane. The method is applied to an automated thin-film battery manufacturing process, and includes die blanking, plate lamination, welding, encapsulation, and electrolyte injection processes. It is mainly by adding a drying device to provide a drying process prior to the lamination in the battery manufacturing process, so that in the process of sequentially stacking the positive, negative electrode plates and the separator membrane into a battery cell in an interval, the drying device is used to continuously dry the separator membrane in advance to ensure that the moisture content of the separator membrane itself is effectively removed.

The drying device of the present invention mainly has a closed space, in which a plurality of sets of rollers at a certain distance from each other are arranged arbitrarily, and a long strip-shaped separator membrane is provided to wind all the rollers to obtain a fully unfolded state. The closed space is provided with an external wind mechanism, and pipeline is used to connect to the closed space to form an in-and-out circulation and delivery function, thereby providing continuous wind to blowup the unfolded separator membrane in the closed space to achieve comprehensive drying effect.

### BRIEF DESCRIPTION OF THE DRAWINGS

FIG. 1 is a general flow chart of a conventional battery process.

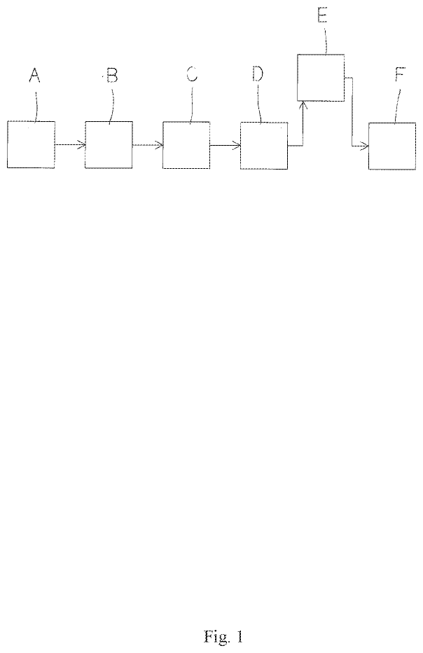

FIG. 2 is a flow chart of a thin film battery manufacturing process according to a preferred embodiment of the present invention.

FIG. 3 is a schematic diagram of a drying device according to a preferred embodiment of the present invention.

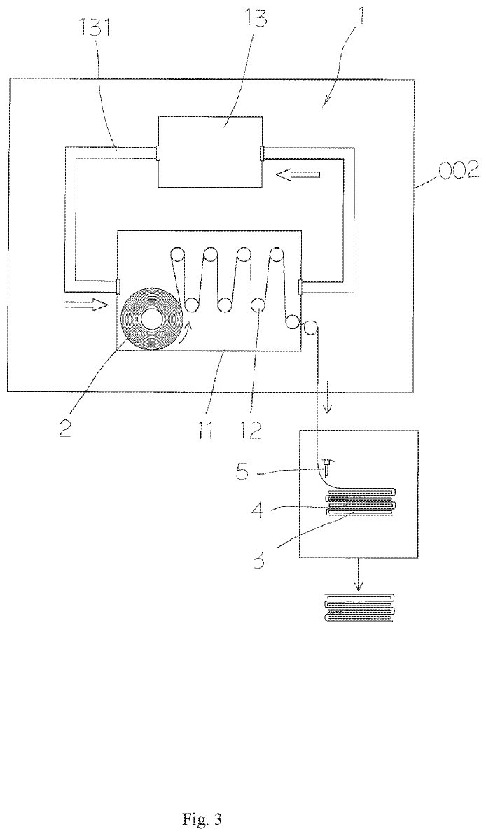

FIG. 4 is a schematic diagram of a drying device according to another preferred embodiment of the present invention.

### DETAILED DESCRIPTION OF THE INVENTION

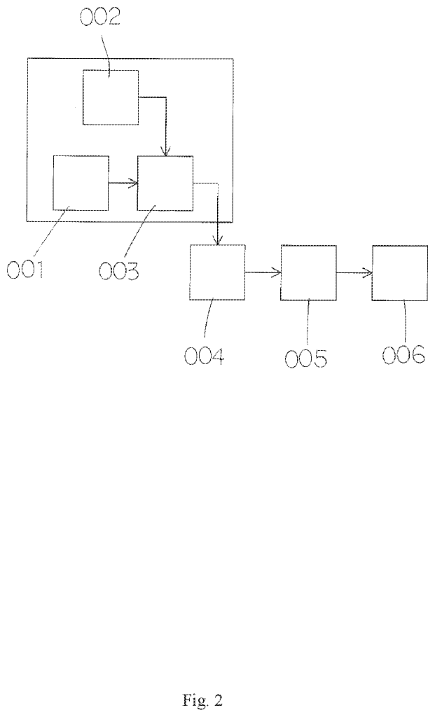

Referring FIG. 2, which discloses a method for drying a battery separator membrane according to a preferred embodiment of the present invention, it is applied to an automated thin-film battery manufacturing process, and includes die blanking (001), drying (002), plate lamination (003), welding (004), encapsulation (005), and electrolyte injection (006) processes, wherein the die blanking (001) process mainly provides an operation for cutting electrode plate and blanking electrode ear; the drying (002) process mainly provides a drying operation for a long strip-shaped separator membrane; the plate lamination (003) process mainly provides positive and negative plates overlapping operation; the welding (004) process mainly performs welding operations on the positive and negative electrodes of the positive and negative plates; the encapsulation (005) operation mainly provides an operation for placing the battery cell into the aluminum-plastic film for encapsulation (including top sealing and side sealing, and leaving one side open); the electrolyte injection (006) process mainly provides an injection of electrolyte into the aluminum-plastic film-sealed battery cell. After the completion, the opening is closed, left for rest, and unified storage.

As shown in HG 3, the drying device (1) designed by the present invention mainly has a closed space (11). Within the closed space (11), a plurality of sets of rollers (12) at a certain distance from each other is arranged to provide the long strip-shaped separator membrane (2) to wind all the rollers (12) in order to obtain a fully unfolded state. In addition, the closed space (11) is provided with an external wind mechanism (13), and pipeline (131) is used to connect to the closed space (11) to form an in-and-out circulation and delivery function, thereby providing continuous wind to blow up the unfolded separator membrane (2) in the closed space (11) to achieve a comprehensive drying effect. The pipelines (131) connected to the closed space (11) in the figure are respectively connected to the front end and rear end of the separator membrane (2), which is the best configuration for circulation and delivery.

The present invention mainly adds a drying device (1) between the die blanking (001) and plate lamination (003) processes during the battery manufacturing for providing a drying (002) process, such that prior to the process of sequentially stacking the positive, negative electrode plates and the separator membrane (2) in an interval into a battery cell, the drying device (1) is used to unfold the separator membrane (2) and continuously and fully dry it in advance to ensure that the moisture content of the separator membrane itself is effectively removed. After completing the overlapping of the positive, negative electrode plates (3, 4) and the separator membrane, a cutter (5) is used to cut off the separator membrane (2) for gluing and positioning.

After the above pre-dried separator membrane (2) is overlapped with the positive, negative electrode plates to finish the plate lamination (002) process, and since the separator membrane (2) itself has been pre-dried to remove moisture and each subsequent process is performed in a closed environment, there is sufficient control over the humidity of the environment. Therefore, after completing the encapsulation (005) process, it is not necessary to proceed with the baking, except directly carrying out the electrolyte injection (006) process. In this way, it is possible to dispense with the need to leave the production line for baking operation and spend a lot of time in drying and then manually return to the production line, thereby achieving manufacturing process of full-automatic blanking to encapsulation integration production. It can not only shorten the process time, but also facilitate the mass production and enhance the economic benefits.

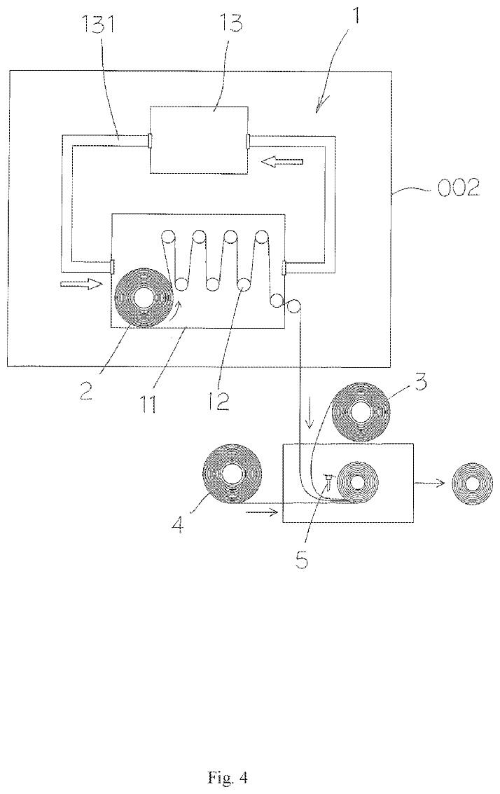

As shown in FIG. 4, the method and device of the present invention are also applicable to a thin film type battery manufacturing process. Prior to the plate lamination (003) process in a manufacturing, a drying device (1) is used to make the separator membrane (2) wind around all the upper and lower rollers (12) in the closed space (11) to get a fully unfolded state, while a strong circulating wind is continuously blown to make the moisture content of the separator membrane (2) itself be surely removed. After that, the plate lamination (003) process is performed to allow the thin and coiled long stripe-like positive, negative electrode plates (3, 4) to lie on the opposite surface of the separator membrane (2), which is followed by cutting off with a cutter (5) to form a coil type battery cell structure. In this embodiment, the addition of drying process (002) and the drying device (1) does not hinder the consistent production process of the original automated production line, and can effectively increase the mass production efficiency to obtain the economic benefits.

Although the present invention has been described in terms of specific exemplary embodiments and examples, it will be appreciated that the embodiments disclosed herein are for illustrative purposes only and various modifications and alterations might be made by those skilled in the art without departing from the spirit and scope of the invention as set forth in the following claims.

1. A method for drying a battery separator membrane is applied to an automated thin-film battery manufacturing process, and includes die blanking, plate lamination, welding, encapsulation, and electrolyte injection processes; it is mainly by adding a drying device to provide a drying process prior to the lamination manufacturing process; the drying device is used to unfold the coiled long stripe-like separator membrane into a fully unfolded state, while the separator membrane is carried out continuous drying to ensure that the moisture content of the separator membrane itself is effectively removed to shorten the processing time and achieve the benefits of full-automatic blanking to encapsulation integration production.

2. A device for drying a battery separator membrane mainly has a closed space, in which a plurality of sets of rollers at a certain distance from each other are arranged arbitrarily, and a long strip-shaped separator membrane is provided to wind around all the rollers to obtain a fully unfolded state; the closed space is provided with an external wind mechanism, and pipeline is used to connect to the closed space to form an in-and-out circulation and delivery function, thereby providing continuous wind to blow up the unfolded separator membrane in the closed space to achieve comprehensive drying effect.
